(19) United States
(12) Patent Application Publication
(10) Pub. No.: US 2007/0076325 A1
(43) Pub. Date: Apr. 5, 2007

(54) Apparatus for indicating a state of a device

(75) Inventors: Zoran Radivojevic, Helsinki (FI); Akseli Anttila, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/231,334

(22) Filed: Sep. 20, 2005

(51) Int. Cl. G11B 21/04

(52) U.S. Cl. 360/272

(57) ABSTRACT

An arrangement for indicating a state of a device comprising a magnet and a coil configured such that one is moveable relative to the other such that, when the device is shaken, the coil generates electrical power and a controller configured to be powered by the coil, to determine the state of the device and to set an output device so as to indicate the state of the device.

### FIELD OF THE INVENTION

The present invention relates to apparatus or arrangement for indicating the state of a device, particularly, but not exclusively, included in, and for indicating the state of, a removable data storage device.

### BACKGROUND ART

Removable data storage devices, such as universal serial bus (USB) flash drives (which are also known as “pen drives”, “thumb drives” and “flash drives”), are well known in art.

To find out how much memory is available in the removable data storage device, a user connects the device to a personal computer (or other similar data processing apparatus having a user interface, such as a mobile communications device) and reads data from the device or data describing the state of the device (usually known “properties”). However, this process is time-consuming and depends upon having access to a computer.

The present invention seeks to provide apparatus for indicating the state of a device.

### SUMMARY OF THE INVENTION

According to a first aspect of the present invention there is provided apparatus for indicating a state of a device comprising a magnet and a coil configured such that one is moveable relative to the other such that, when the device is shaken, the coil generates electrical power, and a controller configured to be powered by the coil, to determine the state of the device and to selectively connect an impedance across the coil in dependence upon the state of the device.

Varying the impedance across the coil can change how the apparatus sounds and/or feels when shaken. This can be used to provide information about the state of the device to the user.

The device may be a data storage device. The controller may be operatively connected to non-volatile memory. The controller may be configured to determine an amount of available memory or a number of files stored in memory.

The apparatus may be included in the device.

The device may include an output device and the controller may be configured to set the output device in dependence upon the state of the device. The output device comprises a display, such as a liquid crystal display (LCD) or a bi-stable display, a light emitting diode (LED) or a device for producing sound.

The state of the device may be set before the controller is powered by the coil. The apparatus may be configured to prevent the user from setting the state of the device.

According to a second aspect of the present invention there is provided apparatus for indicating a state of a device comprising a magnet and a coil configured such that one is moveable relative to the other such that, when the device is shaken, the coil generates electrical power and a controller configured to be powered by the coil, to determine the state of the device and to set an output device so as to indicate the state of the device or a number of files stored in memory.

The device may be a data storage device and the controller may be operatively connected to non-volatile memory and configured to determine an amount of memory available in the non-volatile memory

According to a third aspect of the present invention there is provided a removable data storage device comprising non-volatile memory for storing data, a magnet and a coil, the magnet configured to be slidably moveable through the coil such that, when the device is shaken, the coil generates electrical power and a controller operatively connected to the non-volatile memory and configured to be powered by the coil when the device is shaken, and further configured, when powered, to determine a state of the non-volatile memory and to selectively connect an impedance across the coil in dependence upon the state.

The device may be configured to determine an amount of memory available in the non-volatile memory

According to a fourth aspect of the present invention there is provided a method comprising determining a state of a data storage device and selectively connecting an impedance across a coil in dependence upon the state.

The method may further comprise receiving power from the coil.

According to a fourth aspect of the present invention there is provided a computer readable medium storing a computer program for performing the method.

### BRIEF DESCRIPTION OF THE DRAWINGS

Embodiments of the present invention will now be described, by way of example, with reference to the accompanying drawings in which:

FIG. 1 is a perspective view of an embodiment of a removable data storage device according to the present invention;

FIG. 2 is a cross section of a magnet and coil;

FIG. 3 is a schematic block diagram of the removable data storage device shown in FIG. 1;

FIG. 4 is a schematic block diagram of a controller of the removable data storage device shown in FIG. 3;

FIG. 5 is a schematic block diagram of a power unit of the controller shown in FIG. 4;

FIG. 6 is a schematic block diagram of an impedance-switching unit of the controller shown in FIG. 4;

FIG. 7 illustrates a procedure carried out by the user for determining availability of memory in the removable data storage device shown in FIG. 3; and

FIG. 8 is a process flow diagram of a method of indicating availability of memory in the removable data storage device shown in FIG. 3.

### DETAILED DESCRIPTION OF THE INVENTION

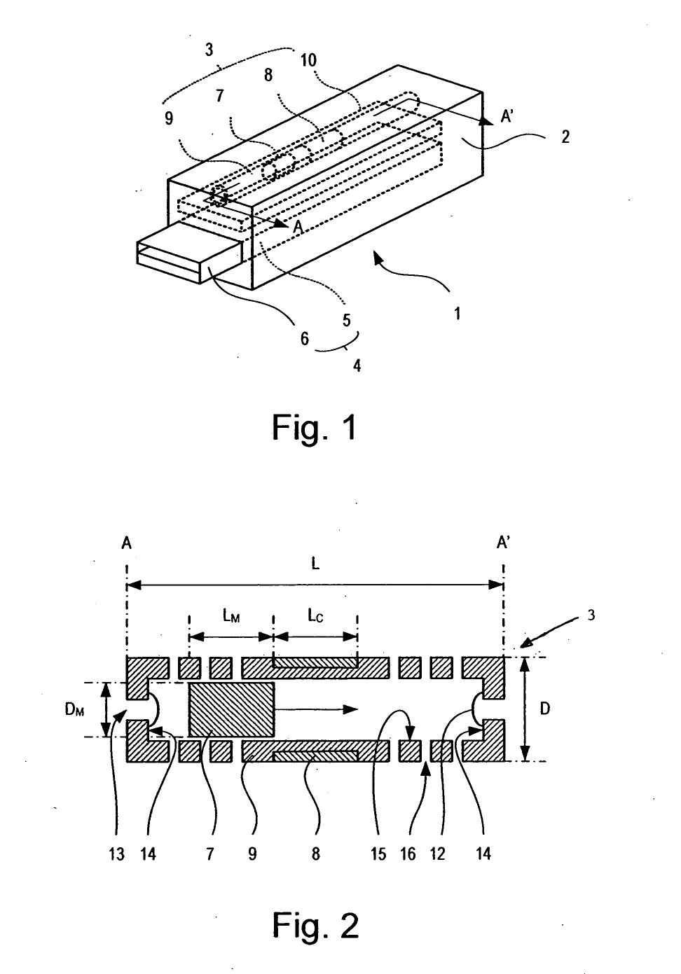

Referring to FIG. 1, an embodiment of a removable data storage device 1 according to the present invention is shown. The removable data storage device 1 has a housing 2 and includes apparatus 3 for indicating a state of the device, which in this case is amount of available memory.

The removable data storage device 1 is in the form of a universal serial bus (USB) flash drive and includes conventional USB flash device 4 which includes memory circuitry 5 and interface 6. However, the device 1 may be another type of removable data storage device 1, such as a memory card, for example a multimedia card (MMC), or hard disk drive. Furthermore, the device 1 need not be a removable data storage device, but may be any type of hand-held or smaller device about a state of which a user may be interested. The state may be a condition of the device, content of the device, a property of the device, a value stored in the device or other property of the device or part of the device. For example, the device may be an electronic key ring and the user may wish to determine whether the key ring has locked or unlocked a vehicle. In another example, the device may be smart card providing an electronic wallet and user may wish to find out how much cash is available. In a different example, the device may be a content rendering device, such as an MP3 player, and the user may wish to find out how many content files are stored without necessarily switching on the device. Other devices includes Image Memory Displays (IMDs) and mobile communications devices and personal data assistants (PDAs).

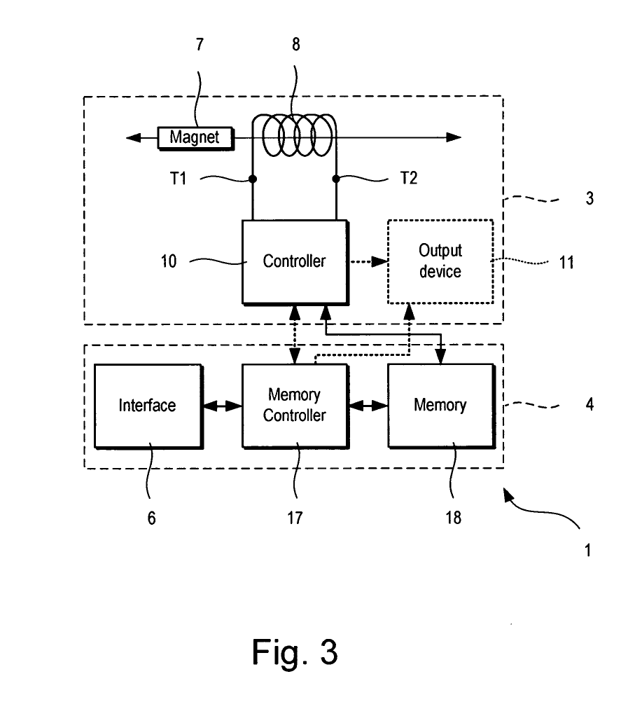

Referring also to FIG. 2, the device state indicating apparatus 3 includes a magnet 7 and a coil 8 (which may also be referred to as a “solenoid”), wound around a tube 9, a controller 10 (hereinafter referred to as the “device state indicating controller 10”) and, optionally, an output device 11 (FIG. 3). The magnet 7 is arranged to be slidable longitudinally within the tube 9, through the coil 8. Resilient members 12 in the form of elastic membranes are mounted over holes 13 on inwardly facing ends 14 of the tube 9 for reversing the direction of motion of the magnet 7 and for producing sound, similar to a loudspeaker. Alternatively, compression springs (not shown) may be used. The magnet 7 and coil 8 are arranged such that, when a user shakes the device 1 along the longitudinal axis of the tube 9, magnet 7 passes back and forth through the coil 8 and the coil 8 generates electrical power.

The tube 9 has a length, L, of about 20 mm and a diameter, D, of about 3 mm. However, the tube 9 may be longer or shorter and may be wider or narrower. For example, the tube 9 may have a length of 6 mm and a diameter of 2 mm. The tube 9 comprises a non-magnetic material. In this embodiment, the tube 9 comprises polyurethane, although other plastics materials can be used. An inner surface 15 of the tube 9 can be provided with an inner sleeve (not shown) comprising a material having a low coefficient of friction, such a polytetrafluoroethylene (PTFE). The tube 9 need not be circular in cross section, but can be oval or polygonal, for example rectangular, and the cross section of the magnet 7 and the coil 8 can be correspondingly shaped. The tube 9 is provided with a recess about its circumference at a midpoint between the ends 14 for receiving the coil 8. The inner surface 15 of the tube 9 may be ribbed so as to as to produce further noise as the magnet 7 rubs against it.

Openings 16 in the tube 9 are provided to help sound propagate out of the tube 9. The openings 16 are in the form of holes arranged either side of the coil 8. The arrangement and diameter of the holes 16 may be varied. The openings 16 may be circular. The openings may be slotted. The openings 16 may be omitted.

The magnet 7 comprises a ferromagnetic material. In this example, the ferromagnetic material is neodymium (Nd), although other ferromagnetic materials such as iron (Fe) can be used. Furthermore, the magnet 7 can be weighted with a dense, non-ferromagnetic material, such as lead (Pb), so as to have a given natural frequency, in other words to provide a given feel and/or to produce a given rattle when the user shakes the device 1. For example, a region of neodymium may be sandwiched between regions of lead.

The magnet 7 has a magnetic field strength of the order of 0.01 or 0.1 T. The magnet 7 has a length, LM, of about 4 mm and a diameter, DM, of about 2 mm. However, the magnet 7 may be longer or shorter and may be wider or narrower. Generally, the lengths of the magnet 7, coil 8 and tube 9 are arranged such that the magnet 7 can clear ends of the coil 8.

The coil 8 comprises about 5000 turns of magnet wire having a thickness of about 100 μm. The coil 8 can have additional or fewer turns and thinner or thicker magnet wire can be used. The coil 8 has a length, Lc, of about 10 mm and a diameter, Dc, of about 3 mm. However, the coil 8 may be longer or shorter and may be wider or narrower. For example, the coil 8 may have a length of 3 mm and a diameter of 1 mm.

The magnet 7 and tube 9 are arranged to be shaken at a frequency of about 1 to 5 Hz. The magnet 7 and coil 8 can produce about 2 to 10 mW of electrical power.

Electromagnetic shielding (not shown) may be provided to shield the rest of the device 1 from the magnet 7.

The length of the tube 9, the choice of material for the inner surface 15 of the tube 9 and/or the diameters of the magnet 7 and tube 9 can be adjusted to vary the way the device 1 feels and/or how it sounds, i.e. amplitude and frequency of the vibration or sound reaching the user, when shaken.

Furthermore, passage of the magnet 7 through the coil 8 will also be subject to a magneto-mechanical resistance which is dependent upon the current flowing through the coil 8. By varying the load across the coil 8, the magneto-mechanical resistance can be varied and so the sensation and/or sound (volume and/or pitch) of the vibration can also be varied. This can be used to provide information to the user and is described in more detail later. This is hereinafter referred to as a “passive mode” of communicating information to the user.

Thus, the magnet 7 and coil 8 not only provide electrical power, but also may also provide an output device for indicating the state of the device by the feel and/or noise with which the magnet 7 rattles when the device 1 is shaken.

The magnet 7 can generate a sound having a level of about 40 to 70 dB. Volume and/or pitch may be varied by adjusting the size of the tube 9 and the mass the magnet 7. Volume may also depend upon the frequency and force with which the device 1 is shaken and the impedance across the coil 8, as will be described in more detail later.

Referring to FIG. 3, the coil 8 is connected to the device state indicating controller 10. The device state indicating controller 10 may additionally be operatively connected to an output device or devices 11, such as a liquid crystal display (LCD), a light emitting diode (LED), bi-stable display or a transducer or device for producing sound, such as a piezoelectric speaker. The USB flash device 4 includes the interface 6, a memory controller 17 and memory 18. The device state indicating controller 10 is operatively connected to the memory 18. In other embodiments, the device state indicating controller 10 may be operatively connected to the memory controller 17. The device state indicating controller 10 and the memory controller 17 may be integrated into a single controller. The memory controller 17 may be connected to the output device 11. The device 1 may be configured to prevent the user from setting the state of the device. For example, it may not be provided with any input device other than, for example, a write protect switch.

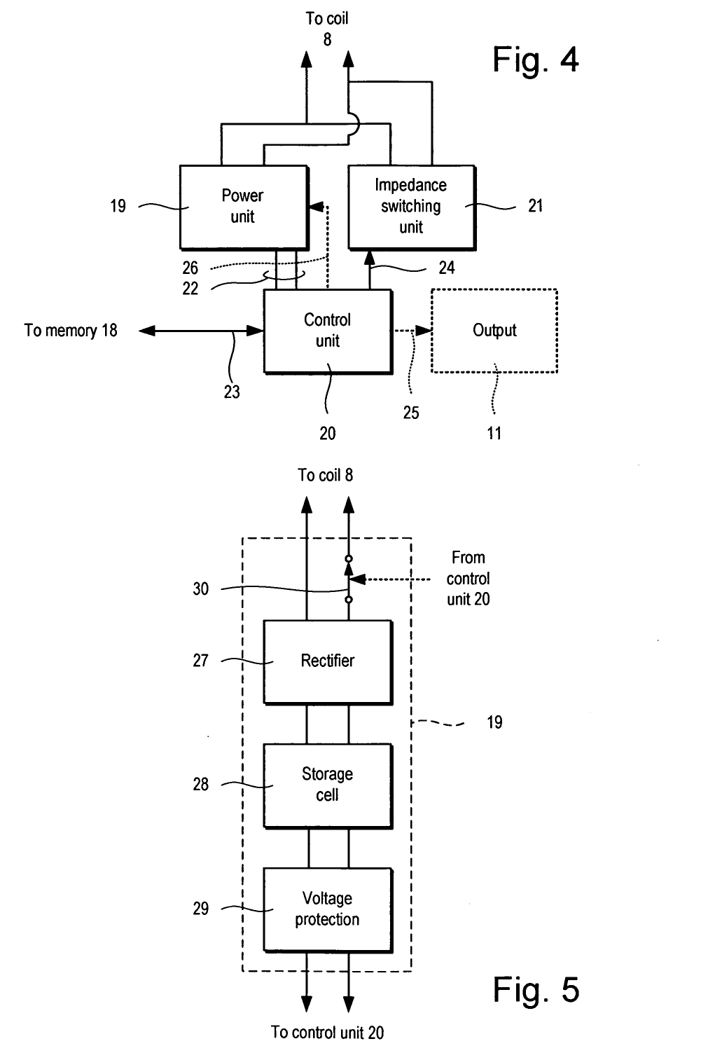

Referring to FIG. 4, the device state indicating apparatus 3 includes a power unit 19, a control unit 20 and an impedance switching unit 21.

The power unit 19 provides power to the control unit 20 through lines 22. The control unit 20 is operatively connected to the memory 18 via bus 23, which may also provide power to memory 18. The control unit 20 provides a control signal to the impedance switching unit 21 via line 24 and, optionally, control signals to an output device and the power unit 19 via control lines 25, 26.

Referring also to FIG. 5, the power unit 19 is connected across the coil 8. When the user shakes the device 1 (FIG. 1), an alternating voltage appears across terminals T1, T2 (FIG. 3) of the coil 8. A bridge rectifier 27 having four diodes (not shown) rectifies the alternating voltage and charges a cell 28 for storing charge.

The storage cell 28 is in the form of an electric double layer capacitor (usually known as a “Gold capacitor”). However, other types of capacitor could be used. The capacitor 28 has an operating voltage of about 3 V (DC) and a capacitance of the order of 0.1 F. The cell 28 may be differently rated. The storage cell 28 supplies power to the control unit 20, optionally via a voltage protection circuit 29, for example comprising a resistor (not shown) and a zener diode (not shown) in series, arranged in parallel across the terminals of the capacitor 28.

The power unit 19 may be optional provided with a normally-closed switch 30 for isolating the coil 8 from the power unit 19. Once enough power has been generated, the switch 30 can be opened so that the power unit 19 does not load the coil 8.

Referring again to FIG. 4, the control unit 20 may be in the form of a microprocessor or microcontroller and may execute a computer program (not shown) stored in local memory (not shown) operatively connected thereto. However, a hard-wired circuit may be used. The control unit 20 is configured, when powered, to determine the state of the device, in this case by scanning memory 18, and to set an output device so as to indicate the state of the device. The output device is provided by the impedance switching unit 21, magnet 7 and coil 8. The impedance switching unit 21 sets a level of magneto-mechanical resistance when the magnet 7 passes through the coil 8 which changes how the device 1 feels and sounds, when shaken.

In some embodiments, the control unit 20 may read a file or a flag stored within memory 18 or locally in the control unit 20 which is set while the storage device 1 is being accessed by a computer (not shown).

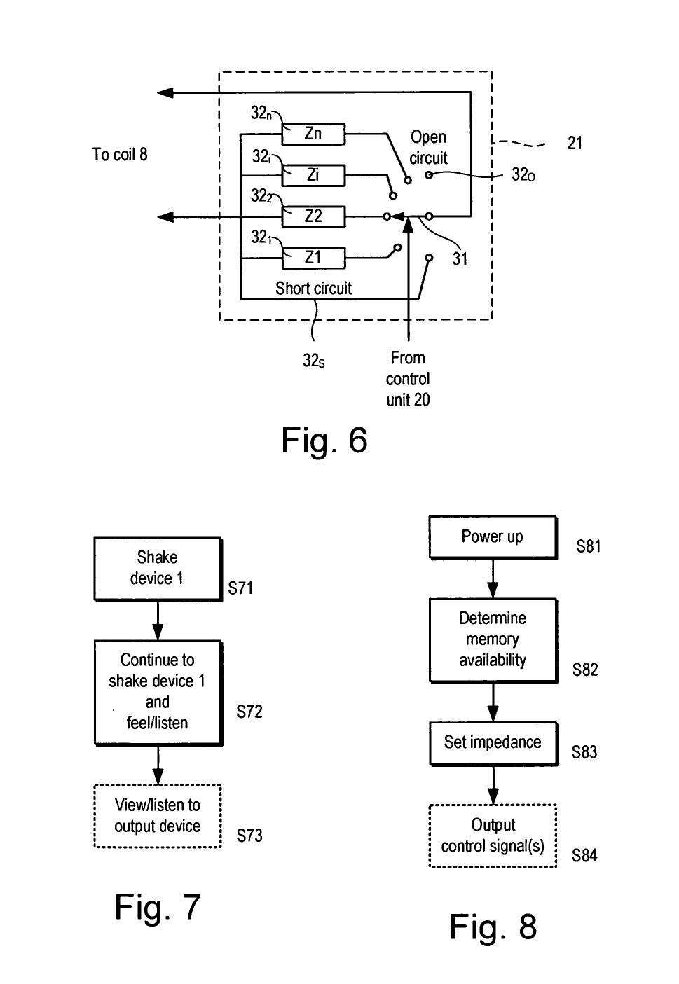

Referring also to FIG. 6, the impedance switching unit 21 comprises a multi-pole switch 31 and a plurality of impedances 32ₛ, 32₁, 32₂, 32ᵢ, 32ₙ, 32_{O}. For example, the impedances may include an electrical short 32ₛ (Z →0), optional fixed impedances32₁ (Z1<Z2< . . . <Zi< . . . <Zn), and/or an open circuit 32_{O} (Z →). The impedances 32₁, 32₂, 32ᵢ, 32ₙ may be resistive, capacitive and/or inductive and may comprise active or passive components.

The impedance switching unit 21 can be implemented using transistors (not shown) in an integrated circuit (not shown)..

If the coil 8 is open circuit or has a high impedance across it, then the coil 8 generates a relatively small back emf which produces a magnetic field resulting in a relatively little magneto-mechanical resistance, in other words the magnet 7 can pass through the coil 8 relatively easily.

If the coil 8 is short-circuited or has a low resistance across it, then the coil 8 generates a relatively large back emf and produces a larger magnetic field resulting in a relatively high magneto-mechanical resistance, i.e. passage of the magnet 7 is more difficult.

As explained earlier, variations in magneto-mechanical resistance can change how the device sounds when shaken. For example, if the magnet 7 moves more slowly, then it will hit the elastic membranes 12 at a lower speed and so produce less noise. Furthermore, there may be more friction between the magnet 7 and the inside of the tube 9. Variations in magneto-mechanical resistance can change how the device feels, when shaken. For example, the faster the magnet 7 moves, the harder the magnet 7 hits the elastic membranes 12, i.e. produces a heavier bounce.

The feel and/or sound of the magnet 7 can be used to indicate a state of a device.

For example, for a memory device, a high magneto-mechanical resistance can be set to damp movement of the magnet 7 so that it moves more slowly and produces less noise so as to indicate that there is little space available in the memory device. A low magneto-mechanical resistance can be set to allow free movement of the magnet 7 so that the magnet 7 moves more quickly and produces more noise so as to indicate that there is a lot of space available in a memory device. The user may perceive that the magnet 7 tends to oscillate with a natural frequency and judge that a characteristic sound is produced.

Similarly, in the case of a smart card serving as a bankcard or electronic purse, sluggish movement of the magnet 7 can be used to indicate that there is little money (or credit) available, whereas relatively unhindered movement of the magnet 7 can be used to indicate a depleted account (or credit) or vice versa.

Likewise, for an electronic key, sluggish movement of the magnet 7 can be used to indicate that a vehicle (or door) is unlocked, whereas relatively unhindered movement of the magnet 7 can be used to indicate the vehicle (or door) is locked or vice versa.

Referring again to FIG. 4, in addition to or as an alternative to the passive mode of communicating information to the user, the device 1 may be configured to communicate information to the user via an output device 11. This is hereinafter referred to as an “active mode” of communicating information to the user.

The output device 11 may be an LED or piezoelectric speaker and the control unit 20 may be configured to control the output device 11 in different ways:

The control unit 20 may activate the output device 11 and time-dependently adjust the output, i.e. s=f(t), where f is a function and t is time. In the case of an LED, the output, s, may be light intensity or, in the case of the piezoelectric speaker, the volume or pitch of a tone.

For example, the control unit 20 may change the output exponentially using on a decay time, to, selected according to the state or condition of the device, which in this example is a memory-related parameter, for instance s =soe ^{-t/t0}, where so is an initial signal value. For example, if four levels are used, then the decay time to can be set to 0.2, 0.7, 1.2 and 2.0 s. Additional or fewer levels may be used and decay time may differ. The number of levels and/or decay times may be user-defined.

The control unit 20 may provide more detailed information by representing a number by a number of pulses, such as pulses of light, hereinafter referred to as “blinks”, or pulses of tone, hereinafter referred to as “beeps”. For example, the number “1” may be represented by a single pulse, the number “2” may be represented by two pulses and so on. Numbers larger than ten can be represented by using a set duration of time, such as 0.5 s, as a separator, i.e. as a pause. For example, a memory-related parameter may be the number of files stored. If the number of files is 135, then the control unit 20 causes the output device to output a sequence one blink, pause, three blinks, pause and then five blinks.

The memory related-parameter may be the proportion of available memory (x/xₜₒₜₐₗ), for example less than 0.05 (x/xₜₒₜₐₗ<0.05), between 0.05 and 0.25 (0.05 x/xₜₒₜₐₗ<0.25), between 0.25 and 0.5 (0.25 x/xₜₒₜₐₗ<0.50) and more than 0.5 (0.5 x/xₜₒₜₐₗ) of memory is available. The memory related-parameter may be the amount of available memory (x), for example less than 1 MB, between 1 MB and 10 MB, between 10 and 100 MB and more than 100 MB. The memory-related parameter may be the number of files. Other memory-related parameters may be used.

In some embodiments, the output device 11 may be a low-power bi-stable display, whereby power is needed to change the display to show a still image (not shown). Thus, the output device 11 may select one of a given number of portions of the display for presenting the information to the user. The information may be presented alphanumerically, for example “Empty” or “Full” or graphically, for example as a level indicator bar.

In other embodiments, the output device 11 may be a display, such as an LCD display.

Referring to FIGS. 4, 7 and 8, a method of operation is described.

The removable data storage device 1 need not be connected to a computer (not shown). The user shakes the device 1 (step S71) until enough power has been generated to power the control unit 20 (step S81). Typically, between 2 and 20 shakes are needed, although the number of shakes can be higher.

While the user continues to shake the device 1, the control unit 20 determines the state of the device, in this case, the amount of available memory (step S82).

The control unit 20 sends a control signal 24 to the impedance switching unit 21 according to the available memory (step S83). Optionally, the control unit 20 may decouple the power unit 19 from the coil 8 by opening switch 30 (FIG. 5). The control unit 20 may send the control signal 24 a predetermined number of shakes (or duration of time) after starting operation or may send an initial prompt or warning signal to prepare the user so that the user expects the output. While the user continues to shake the device 1, they may listen to or feel the response of the device 1 so as to ascertain the memory availability (step S72).

The control unit 20 may also send a control signal 25 to the output device 11 (step S84). The user can view or listen to the output device 11 so as to ascertain the memory availability (step S73).

It will be appreciated that many modifications may be made to the embodiments hereinbefore described. The magnet 7 need not move linearly. Instead, the magnet 7 may be mounted on a pivoted arm. The apparatus may be provided as a separate device, connectable to and for use with conventional devices.

What is claimed is:

1. An apparatus for indicating a state of a device comprising:
a magnet and a coil configured such that one is moveable relative to the other such that, when the device is shaken, said coil generates electrical power; and
a controller configured to be powered by said coil, to determine the state of the device and to selectively connect an impedance across the coil in dependence upon the state of the device.

2. The apparatus according to claim 1, wherein the device is a data storage device.

3. The apparatus according to claim 1, wherein the device is an electronic key.

4. The apparatus according to claim 1, wherein the device is an electronic card.

5. The apparatus according to claim 4, wherein the electronic card is an electronic wallet.

6. The apparatus according to claim 1, wherein the controller is operatively connected to non-volatile memory.

7. The apparatus according to claim 6, wherein the controller is configured to determine an amount of available memory.

8. The apparatus according to claim 6, wherein the controller is configured to determine a number of files stored in memory.

9. The apparatus according to claim 1, wherein the apparatus is included in the device.

10. The apparatus according to claim 1, further comprising an output device and wherein the controller is configured to set the output device in dependence upon the state of the device.

11. The apparatus according to claim 10, wherein the output device comprises a display.

12. The apparatus according to claim 11, wherein the output device comprises a liquid crystal display.

13. The apparatus according to claim 11, wherein the output device comprises a bi-stable display.

14. The apparatus according to claim 10, wherein the output device comprises a light emitting diode (LED).

15. The apparatus according to claim 10, wherein the output device comprises a device for producing sound.

16. The apparatus according to claim 1, wherein the state of the device is set before the controller is powered by said coil.

17. The apparatus according to claim 1, wherein the apparatus is configured to prevent the user from setting the state of the device.

18. An apparatus for indicating a state of a device comprising:
a magnet and a coil configured such that one is moveable relative to the other such that, when the device is shaken, said coil generates electrical power; and
a controller configured to be powered by said coil, to determine the state of the device and to set an output device so as to indicate the state of the device.

19. The apparatus according to claim 18, wherein the device is a data storage device, the controller is operatively connected to non-volatile memory and the controller is configured to determine an amount of memory available in the non-volatile memory.

20. A removable data storage device comprising:
non-volatile memory for storing data;
a magnet and a coil, the magnet configured to be slidably moveable through the coil such that, when the device is shaken, the coil generates electrical power; and
a controller operatively connected to the non-volatile memory and configured to be powered by said coil when the device is shaken, and further configured, when powered, to determine a state of the non-volatile memory and to selectively connect an impedance across the coil in dependence upon said state.

21. The apparatus according to claim 20, wherein the controller is configured to determine an amount of memory available in the non-volatile memory.

22. A method, comprising:
determining a state of a data storage device; and
selectively connecting an impedance across a coil in dependence upon said state.

23. The method according to claim 22, further comprising:
receiving power from said coil.

24. A computer readable medium storing a computer program for performing a method according to claim 22.
